(19) United States
(12) Patent Application Publication
(10) Pub. No.: US 2024/0261881 A1
(43) Pub. Date: Aug. 8, 2024

(54) METHOD FOR PRODUCING A COMPONENT WITH A TOOTHING

(71) Applicant: Miba Sinter Austria GmbH, Laakirchen (AT)

(72) Inventors: Horst ROESSLER, Krenglbach (AT); David JOCHER, Ebensee (AT); Martin OHLER, Vorchdorf (AT); Alexander MUELLER, Altmuenster (AT)

(73) Assignee: Miba Sinter Austria GmbH, Laakirchen (AT)

(21) Appl. No.: 18/429,676

(22) Filed: Feb. 1, 2024

(30) Foreign Application Priority Data
Feb. 8, 2023 (AT) A50076/2023

(51) Int. Cl. B23F 19/05

(52) U.S. Cl. CPC B23F 19/05

(57) ABSTRACT

A method for manufacturing a component having a toothing, which has teeth with tooth roots, tooth tips and tooth flanks, includes the steps of: manufacturing a component body from a metallic material, forming the toothing on the component body, mechanically finishing the toothing so that the surface of the toothing has a first surface roughness, wherein after mechanical finishing, the toothing is heat treated to form a second surface roughness of the mechanically finished surface, which is less than the first surface roughness, and/or wherein the component body is configured to be divided in the radial direction, forming a first radially inner annular part and a second radially outer annular part, an elastomer being arranged in an undulating manner between the first radially inner and the second radially outer annular part.

### CROSS REFERENCE TO RELATED APPLICATIONS

Applicant claims priority under 35 U.S.C. § 119 of Austrian Application No. A50076/2023 filed Feb. 8, 2023, the disclosure of which is incorporated by reference.

### BACKGROUND OF THE INVENTION

### 1. Field of the Invention

The invention relates to a method for manufacturing a component, in particular an annular component, which has teeth with tooth roots, tooth tips and tooth flanks, comprising the steps of: manufacturing a component body made of a metallic material, forming the toothing on the component body, mechanically finishing the toothing so that the surface of the toothing has a first surface roughness.

The invention further relates to a component, in particular an internal gear, with a component body, upon which a toothing is arranged or formed, the teeth having tooth roots, tooth tips and tooth flanks, the toothing being mechanically finished.

### 2. Description of the Related Art

What are known as electric axles are used in the drive unit of electric vehicles and hybrid applications. In the prior art, the term “electric axle” refers to solutions for the electric drive of battery-powered electric vehicles and hybrid applications. The electric motor used, which converts electrical energy into mechanical energy, transmits the torque to a transmission. The transmission translates the speed of the electric motor to the level required on the drive shaft and increases the motor torque at the same time. Electric axes are often equipped with single-stage or two-stage spur gears or planetary gears. This makes possible the representation of axially parallel or coaxial architectures.

In order to be able to present as low-noise a drive concept as possible, especially since electric motors are very quiet anyway, the requirements of noise-reduced transmission stages are very high. It is known that sintered gears can be manufactured in net-shape quality. However, a net-shape approach is not sufficient to show a quiet planetary gear toothing and mechanical finishing of the toothing is necessary. However, this processing leads to the formation of surface structures on the tooth flanks, which can cause noise emissions during tooth engagement.

### SUMMARY OF THE INVENTION

The underlying problem of the current invention is to improve the NHV (noise, vibration, harshness) properties of a toothing. A further partial problem of the invention is to provide a toothing with improved NHV properties.

The problem of the invention is solved in the method mentioned at the beginning by heat treating the toothing after mechanical finishing in order to form a second surface roughness of the mechanically finished surface less than the first surface roughness, and/or by configuring the component body to be divided in the radial direction, forming a first radially inner annular part and a second radially outer annular part, an elastomer being arranged in an undulating manner between the first radially inner and the second radially outer annular part.

The problem of the invention is further solved with the component mentioned at the beginning by heat treating the toothing and/or by configuring the component body to be divided in the radial direction, forming a first annular part and a second annular part, an elastomer being arranged in an undulating manner between the first and the second annular part.

Surprisingly, it has been found that the surface roughness of the toothing can be reduced by the heat treatment. This makes it possible for the mechanical processing of the toothing to be carried out before the heat treatment in order to increase the accuracy of the teeth. This in turn offers the advantage that tools used for mechanical finishing have a longer service life, since the toothing can be even softer before the heat treatment. In addition, the duration of the mechanical finishing of the toothing can be reduced by the sequence of the method steps, since the processed surface can be left rougher. The transmission path (tooth engagement up to a housing) can be interrupted due to the alternative or additional radial division of the component with an interposed rubber track, meaning the acoustic behavior can be (further) improved.

According to an embodiment of the invention, it can be provided that the toothing is manufactured simultaneously with the manufacturing of the component body, meaning a further reduction of the process time can be achieved.

According to a further embodiment of the invention, the component body (with the toothing) is manufactured from a sintered material by pressing a powder to form a green compact and sintering the green compact into the component body, as a result of which the component can be manufactured relatively easily with a low tolerance, at least in the region of the toothing, even before the mechanical finishing. Furthermore, it is more tool friendly for all necessary processing to take place in the green compact state.

According to one embodiment, provision can be made for at least the toothing to be re-compressed after sintering in order to rapidly increase component accuracy. This makes possible a further reduction in mechanical finishing after sintering.

According to a further embodiment of the invention, it can be provided that machining is carried out as mechanical finishing in order to reduce the processing time.

It has proven to be particularly effective with regard to the above-mentioned effects for nitration or nitro-carburization to be carried out as heat treatment. This type of heat treatment can achieve a greater reduction in the surface roughness of the mechanically processed surface. It is assumed that this is due to structural changes as a result of nitration or nitro-carburization.

These effects can particularly be intensified if, according to one embodiment, plasma nitration is carried out as nitration or plasma nitro-carburization is carried out as nitro-carburization.

According to a further embodiment of the invention, provision can be made for a radially inner surface of the second radially outer annular part and a radially outer surface of the first radially inner annular part to be configured in a toothed manner. This enables the reduction of loads on the elastomer track between the annular parts during operation of the component.

According to an embodiment, provision can also be made for the radially inner surface of the second radially outer annular part and/or the radially outer surface of the first radially inner annular part to be rolled with and/or without a cutting tool. The advantage thereof is that the manufacturing tolerances of the component can be reduced by rolling with or without a cutting tool. In turn, this enables an increase in the accuracy of the cavity dimensions between the annular parts, in which the at least one elastomer element is arranged. As a result, the at least one elastomer element is subjected to a more uniform pre-load. In this way, the stiffness value of the component or of a toothing arrangement with two meshing gears, one of which is configured as a component according to the invention, can be preset with greater accuracy. Rolling with or without a cutting tool also offers a cost advantage compared to other processing methods for increasing component accuracy.

According to a further embodiment of the invention, it can be provided that the radially inner surface of the second radially outer annular part and/or the radially outer surface of the first radially inner annular part are/is configured in the form of a spur toothing or helical toothing, wherein according to an embodiment, it can be provided that the spur toothing or helical toothing of the radially inner surface of the second radially outer annular part and/or the radially outer surface of the first radially inner annular part are/is configured in the form of a cycloidal toothing, in particular an involute toothing. On the one hand, these tooth shapes can be processed more easily by means of tools for rolling with or without a cutting tool. On the other hand, this tooth shape offers the possibility of modifying stiffness by appropriate modifications to the toothing or the toothings. By doing so, the characteristic curve of the stiffness can be influenced individually at the first or second projections by changing the engagement angle or the helix angle in a progressive or linear manner, for example. Furthermore, the dependence of the torsional stiffness on the radial stiffness and on the axial stiffness or the tilt stiffness can thus be modified/influenced.

According to a further embodiment of the invention, it can be provided that the heat treatment is carried out such that the toothing has a surface tension according to ISO 8296 DIN 53364 of a maximum of 55 mN/m, in particular between 20 mN/m and 50 mN/m after the heat treatment.

According to another embodiment of the invention, in order to further improve the NHV properties, it can be provided that the toothing has a surface roughness with an arithmetic mean roughness Ra according to DIN EN ISO 4287:2010 between 0.025 μm and 2.5 μm.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows an internal gear with an internal toothing;

FIG. 2 shows a micrograph of the surface of a tooth of a toothing after mechanical finishing;

FIG. 3 shows a micrograph of the surface of the tooth according to FIG. 2 after the heat treatment; and

FIG. 4 shows an embodiment of an internal gear.

### DETAILED DESCRIPTION OF PREFERRED EMBODIMENTS

It is worth noting here that the same parts have been given the same reference numerals or same component designations in the embodiments described differently, yet the disclosures contained throughout the entire description can be applied analogously to the same parts with the same reference numerals or the same component designations. The indications of position selected in the description, such as above, below, on the side etc. refer to the figure directly described and shown, and these indications of position can be applied in the same way to the new position should the position change.

Unless otherwise explicitly stated, references to standards always refer to the most recent version of these standards as of the filing date of the first application establishing priority.

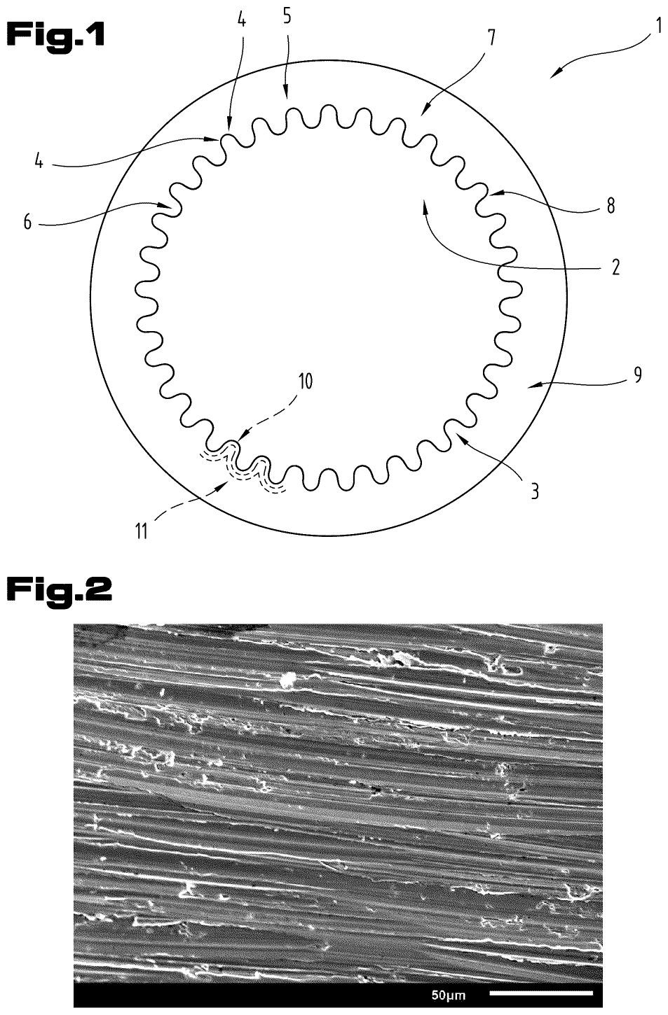

FIG. 1 shows a metallic component 1 in the form of an internal gear. This is annular and has a toothing 2 in the form of an internal toothing. Since such components 1 are known per se, there is no need to further describe them.

Component 1 is, in particular, a metallic sintered component. However, the component 1 can also be manufactured from a solid material, for example cast or stamped or embossed or deep-drawn, etc. Solid material here means a metallic material which, with the exception of defects, has no pores, as is usually the case with sintered components 1.

A steel or sintered steel can be used as the material, for example. However, other metallic materials, such as materials based on copper-based alloys, etc., can also be used. However, the material in the preferred embodiment necessarily contains iron, which particularly preferably forms the matrix of the material.

Furthermore, the invention is explained with reference to an internal gear. However, the component 1 can generally be a component with a toothing 2, such as a (transmission) gear, a toothed belt wheel, a sprocket, a rack, etc. The component 1 can further have a spur toothing or a helical toothing. However, the component 1 in the preferred embodiment is an internal gear for a planetary gear, in particular in the embodiment of the component 1 according to FIG. 4.

The toothing 2 (that can also be referred to as toothed gearing) can be an internal toothing or an external toothing, for example a spur gearing.

The toothing 2 has teeth 3. The teeth 3 have tooth flanks 4, tooth heads 5 and tooth roots 6.

Reference is made to DIN 3998 with regard to the definition of the regions of the tooth flanks 4, the tooth tips 5 and the tooth roots 6.

A tooth root 6 is understood to mean the region between the root circle 7 and the beginning of the engagement region of the tooth 3 in the toothing of a further component, in particular a gear.

The tooth flank 4 is the region of engagement of the tooth 3 in the toothing of the further component. The tooth flank 4 thus adjoins the tooth root 6.

The tooth tip 5 adjoins the tooth flank 4 and is the region between the engaging end of the further component and the tip circle 8.

The toothing 2 of the component 1 is formed or arranged on a component body 9.

The component 1 can be produced by a melt-metallurgical process, for example a casting process. As such methods are known per se, reference is made to the relevant prior art for details.

However, the component 1 is manufactured using a powder metallurgical method, i.e. is preferably a sintered component, in the preferred embodiment. For this purpose, a green compact is manufactured in a corresponding mould (die) from a sintered powder, which can be produced from the individual (metallic) powders by mixing, wherein the powders used can optionally be pre-alloyed. The green compact preferably has a density greater than 6.8 g/cm³.

The green compact is subsequently dewaxed at customary temperatures and sintered in one, two or more stages and then preferably cooled to room temperature. Sintering can take place at a temperature between 900° C. and 1300° C., for example.

Since these processes and the process parameters used are also known from the prior art, reference to the relevant prior art is made in this regard in order to avoid repetition.

Regardless of the method used to manufacture the component 1, mechanical finishing of the toothing 2 takes place after manufacturing the component body 9, which is preferably already manufactured with the toothing 2, in order to reduce the tolerances of the toothing 2. The tooth flanks 4 and/or the tooth tips 5 and/or the tooth roots 6 of the toothing 2 can be processed during.

If the toothing 2 is not already manufactured at the same time as the component body 9, it is subsequently introduced into the component body 9 by means of cutting or machining processes.

For a sintered component, the mechanical finishing of the toothing 2 can also take place at least partially on the green compact. However, mechanically finishing sintered components is preferably carried out at least partially only after sintering in order to be able to take sintering delays into account.

Mechanical finishing can be carried out partially by pressing. In the case of sintered components in particular, the toothing 2 can be surface-compacted by repressing or calibrating. In this case, the porosity of a sintered component after sintering proves to be an advantage as it facilitates compaction of the material.

Re-compression can take place up to a density between 95% and 99% of the total density of the material. The total density refers to the density of a melt-metallurgically manufactured component 1, i.e. a component 1 without pores (according to the aforementioned definition).

In the preferred embodiment, the mechanical finishing of the toothing 2 is carried out at least partially by means of at least one machining method. The machining can be carried out by milling, punching, broaching, filing, grating, scraping or, preferably, by honing, e.g. with a honing ring, for example.

As a result of the mechanical finishing, the processed surface obtains a first surface roughness. This surface can have a roughness with an arithmetic mean roughness Ra according to DIN EN ISO 4287:2010 between 0.1 μm and 3 μm, for example. Furthermore, this surface can have an average roughness depth Rz according to DIN EN ISO 4287:2010 between 1.5 μm and 16 μm.

As a surface with this type of roughness usually has poor NHV properties, the roughness of the mechanically finished surface is reduced. To reduce the surface roughness, the component 1 or at least the toothing 2 is heat treated. The heat treatment creates a second surface roughness less than the first surface roughness. In particular, the heat-treated surface can have a roughness with an arithmetic mean roughness Ra according to DIN EN ISO 4287:2010 between 0.025 μm and 2.5 μm. Furthermore, this surface can have an average roughness depth Rz according to DIN EN ISO 4287:2010 between 0.8 μm and 15 μm.

In the case of sintered components, mechanical finishing takes place after sintering and (immediately) before heat treatment.

Preferably, no further processing of the component 1 takes place after the heat treatment (with the exception of cleaning, packaging, etc.).

The heat treatment can be carried out, for example, by means of case hardening with oil quenching (temperature: 800° C.-950° C., duration: 1 h-48 h, carburizing medium: gas atmosphere, molten salts, carburizing powder/granules; quenching medium: hardening oil), by low-pressure carburizing with gas quenching (LPC) (temperature: 800° C. to 1200° C., duration: 1 h-20 h, carburizing medium: propane, acetylene, quenching medium: nitrogen, helium), low-pressure carburizing with gas quenching (temperature: 900° C. to 1200° C., duration: 1 h to 20 h, carburizing medium: propane, acetylene, ammonia, quenching medium: nitrogen, helium), fixture hardening (carburizing+hardening on mandrel with polymer quenching) (temperature: 800° C. to 950° C., duration: 1 h to 48 h, carburizing medium: gas atmosphere, molten salts, carburizing powder/granules, quenching medium: water+polymer).

However, in the preferred embodiment, it is provided that a nitration, in particular a plasma nitration, or nitro-carburization, in particular a plasma nitro-carburization, is carried out as the heat treatment. This can be selected from a range of 350° C. and 600° C., in particular selected from a range of 400° C. and 550° C. Though the temperature may vary during the process, the temperature is within the stated temperature range. The duration of this plasma treatment can range from 1 hour to 60 hours. Hydrogen or nitrogen or argon or a mixture thereof, for example a mixture of hydrogen and nitrogen, can be used as the atmosphere in the plasma chamber. The ratio of the volume fractions of hydrogen and nitrogen in this mixture can be selected from a range of 100:1 to 1:100. Though the volume fractions of hydrogen and nitrogen can vary during the process, the ratios are necessarily within the specified ranges. Additional process gases may be present, the total proportion of which in the atmosphere is a maximum of 30% by volume.

The electrical voltage between the electrodes can be selected from a range of 300V to 800V, in particular from a range of 450V to 700V. It is also possible for the voltage to be varied during the plasma treatment.

At least two separate electrodes can be used and the component 1 itself can be connected as an electrode for this purpose.

The pressure in the treatment chamber during the plasma treatment of the component 1 can be selected from a range of 0.1 mbar to 10 mbar, in particular from a range of 2 mbar to 7 mbar.

Instead of a plasma treatment, the nitration or carbonitration can also be carried out using one of the aforementioned methods.

Nitration or nitro-carburization increases the nitrogen content and possibly the carbon content in the component 1 in areas close to the surface due to nitrogen and carbon retention. The term “increases” also comprises an increase in this content starting from 0% by weight prior to the treatment.

Nitration or nitro-carburization forms a bonding layer 10 (directly) below the mechanically finished surface.

A bonding layer is understood to mean a layer in which iron nitrides and/or iron carbonitrides are present. These bonds are formed by the reaction of the iron with the nitrogen and/or the carbon. The term “bonding layer” therefore refers to these bonds and not necessarily to a layer that establishes a connection to another layer. However, the latter may apply if a further layer is deposited on the surface of the toothing 2 after the heat treatment.

If the material of the component 1 also has other elements, such as chromium and molybdenum, these can also form nitrides, which can be present in a diffusion layer 11.

A diffusion layer 11 is understood to be a layer that is formed in particular (directly) below the bonding layer 10. The diffusion layer 11 is formed by diffusing nitrogen and optionally carbon into the component during nitration or nitro-carburization. A diffusion layer 11 is thus a layer in which nitrogen and optionally carbon are embedded in the matrix interstitially and/or in the form of nitride precipitates.

The bonding layer 10 and the diffusion layer 11 are indicated by dashed lines in FIG. 1.

The bonding layer 10 can have a layer thickness between 1 μm and 20 μm, in particular between 2 μm and 10 μm. Furthermore, the bonding layer 10 can have a density between 6.50 g/cm³ and 7.45 g/cm³. In general, the bonding layer 10 can have a density that is between 82% and 95% of the density of the solid material. In particular, at least 90% of the iron nitrides in the bonding layer 10 are formed by γ-nitride Fe₄N.

The diffusion layer 11 can have a layer thickness between 50 μm and 300 μm, in particular between 75 μm and 250 μm. Furthermore, the diffusion layer 11 can have a density between 6.90 g/cm³ and 7.85 g/cm³. In general, the bonding layer 10 can have a density that is between 82% and 95% of the density of the solid material. In particular, at least 90% of the iron nitrides in the diffusion layer 11 are formed by ε-nitride Fe₃N.

According to an embodiment of the component 1, by using the aforementioned parameters of heat treatment, in particular (plasma) nitration or (plasma) carbonitration, a component 1 can be manufactured that has a toothing 2 that has a surface with a surface tension according to ISO 8296 DIN 53364 of maximum 55 mN/m, in particular between 20 mN/m and 50 mN/m.

To evaluate the invention, an internal gear was manufactured as a sintered component. The material used for this purpose was a sintered steel with the composition 0.15% by weight−0.3% by weight C+0.3% by weight−0.6% by weight Mo+2.5% by weight−3.5% by weight Cr, the remainder to 100% by weight Fe. The parameters of the sintering process correspond to those mentioned above.

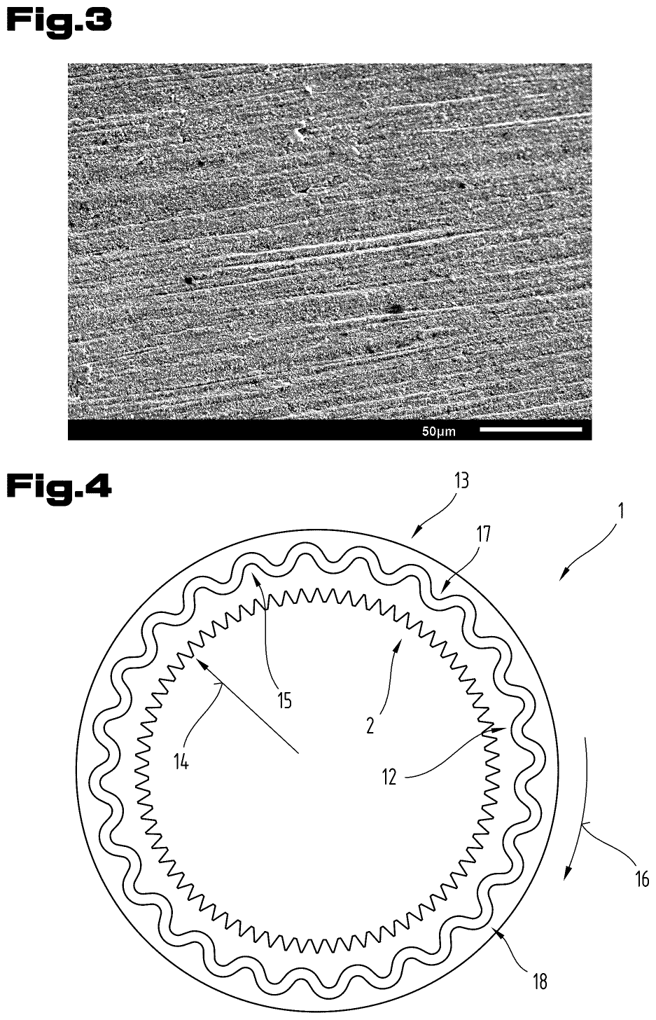

After sintering, the toothing 2 of the internal gear was honed. This resulted in a surface roughness, which is shown in FIG. 2. FIGS. 2 and 3 each show a scanning electron microscope image of a surface section of the internal gear in the region of the toothing 2 before and after the heat treatment. As is visible in FIG. 3, a significantly lower surface roughness was achieved by the heat treatment, which was carried out as plasma nitro-carburization (for parameters, see above) in this case. A reduction in the noise emission peak value of at least 2 dB or more can be achieved by improving the roughness values by the heat treatment.

FIG. 4 shows a further embodiment of a component 1 in the form of an internal gear. This embodiment can stand alone as an invention in its own right. However, it can cause a further improvement in the NHV properties of the component 1 when combined with at least one of the aforementioned embodiments of the component 1.

The gear 1 comprises a first radially inner annular part 12 and a second radially outer annular part 13. The first radially inner annular part 13 has the toothing 2. The first radially inner annular part 12 is arranged radially below (inside) the second radially outer annular part 13.

The first radially inner annular part 12 and/or the second radially outer annular part 13 preferably consist of a metallic material.

The first radially inner annular part 12 has a plurality of first projections 15 projecting outward in the radial direction 6. These first projections 15 are arranged on the radially outer circumferential surface of the first radially inner annular part 12, in particular integrally connected thereto. These first projections 15 are preferably arranged in a uniformly distributed manner over the circumference of the first radially inner annular part 12 in a circumferential direction 16 of the component 1.

The second radially outer annular part 13 has a plurality of second projections 17 which project in the radial direction 14 and, in contrast to the first projections 15, are not arranged to protrude outward but inward. The second projections 17 are arranged on an inner lateral surface of the second radially outer annular part 13, in particular integrally connected thereto. The second projections 17 are also preferably arranged in a uniformly distributed manner over the circumference of the second radially outer annular part 13 in the circumferential direction 16 of the component 1.

Recesses are formed between the second projections 17 in the circumferential direction 10. Similarly, recesses are formed between the first projections in the circumferential direction 10. The arrangement of the recesses is such that the first projections 15 are at least partially, in particular completely, accommodated in the recesses between the second projections 17, and the second projections 17 are at least partially, in particular completely, accommodated in the recesses between the first projections 15 as can be seen in FIG. 4, for example. “Completely” here means that the first projections 15 are slightly spaced apart from the inner lateral surface and the second projections 17 are slightly spaced apart from the outer surface of the first radially inner annular part 12 to enable the relative rotatability of the first annular part 12 with respect to the second annular part 13 in the circumferential direction 16.

The spaced arrangement of the first radially inner annular part 12 from the second radially outer annular part 13 creates a circumferential cavity (gap) between these annular parts 12, 13. An elastomer element 18 is arranged therein. In particular, the cavity is filled by the elastomer element 18. Preferably, only a single annular elastomer element 18, which is continuous in the circumferential direction 16, is arranged. However, it is also possible to use a plurality of elastomer elements 18 that are separate from one another. If necessary, the elastomer element 18 can be connected (integrally bonded) to the first and/or the second annular part 12, 13.

The elastomer element 18 consists at least partially of a rubber-elastic material, for example of an (X)NBR ((carboxylated) acrylonitrile-butadiene rubber), HNBR (hydrogenated nitrile rubber), a silicone rubber (VMQ), NR (natural rubber), EPDM (ethylene-propylene-diene rubber), CR (chloroprene rubber), SBR (styrene-butadiene rubber), etc., wherein material mixtures can also be used here.

The elastomer element 18 can also have regions made of rubber-elastic materials that are different from one another. However, the elastomer element 18 preferably consists exclusively of a rubber-elastic material.

As a result of said first and second projections 15, 17, the elastomer element 18 is configured in an undulating manner (viewed in the axial direction).

The first projections 15 and/or the second projections 17 can be configured in the form of a toothing, as can be seen from FIG. 4, for example. (As shown in the figures), this toothing can be configured in the form of a spur toothing or in the form of a helical toothing.

It is preferably provided that the first projections 15 of the first radially inner annular part 12 and/or the second projections 17 of the second radially outer annular part 13 are rolled with or without a cutting tool. In particular, it can be provided that the first projections 15 of the first radially inner annular part 12 and/or the second projections 17 of the second radially outer annular part 13 are configured in the form of a cycloidal toothing. Cycloidal toothings for gears are known per se from the prior art, so there is no need to explain the terms. In the preferred embodiment, the first projections 15 and/or the second projections 17 are configured as involute teeth.

The cycloidal toothing can be manufactured with a tool for rolling with or without a cutting tool so that both flanks of the first projections 15 and/or both flanks of the second projections 17 are preferably formed identically.

Forming can be carried out in particular by means of skiving but also by means of hobbing, scraping, etc. In particular, in the case of first annular parts 12 and/or second parts 13 manufactured by powder metallurgy, there is also the alternative or additional option to carry out primary forming using a die and that the first projections 15 and/or the second projections 17 are calibrated using an embossing gear by rolling.

According to an embodiment, it can be provided that the cycloidal toothing has an engagement angle between 0° and 90°, in particular between 5° and 60°, between 8° and 45°, for example. The term “engagement angle” is used in the manner conventional for gears. Accordingly, the contact point of two tooth flanks moves on a straight line known as the engagement path during the entire engagement. The angle by which the engagement path is inclined with respect to the vertical (in the case of central axes of the first annular part 12 or second annular part 13 and the tool for rolling with or without a cutting tool extending through a common horizontal line) is the engagement angle. This corresponds to the flank angle of the reference profile.

When the toothings of the first projections 15 and/or the second projections 17 are configured as helical toothings, it can be provided that the helical toothings have a helix angle between 0° and 45°, in particular between 5° and 35°, between 8° and 25°, for example. If both the first projections 15 and the second projections 17 are configured as helical toothings, both helical toothings preferably have the same helix angle. However, embodiments with different helix angles are also possible, in which case the helix angles preferably differ from one another by no more than 10°, in particular no more than 8°, no more than 5°, for example.

The term “helix angle” refers to the angle that the extension of the projections 15 or 17 have in relation to the axial direction. Accordingly, a helix angle of 0° designates a spur toothing.

Preferably, the first projections 15 and/or the second projections 17 are configured symmetrically when viewed in cross section.

According to a preferred embodiment of the component 1, it can be provided that the elastomer element 18 post-forms the flanks of the first projections 15 of the first radially inner annular part 12 and/or the flanks of the second projections 17 of the second radially outer annular element 13, i.e. in particular has a form inverse to the form of the cycloidal toothing of the first projections 15 and/or second projections 17.

To manufacture the elastomer element 18, a pre-press of the elastomer for the elastomer element 18, can be inserted into the cavity between the two annular parts 12, 13 and vulcanized therein, or corresponding forming is carried out outside the cavity and the finished elastomer element 18 is inserted into the cavity.

It should be noted at this point that the cavity between the two annular parts 12, 13 can be configured with a constant thickness in the radial direction over the entire circumference. However, it is also possible for the radial width of the cavity to vary in the circumferential direction 16. For example, a radial distance of 0.5 mm at most can be formed between the tips and the roots of the first and second projections 15, 17. The distance between the flanks of the projections 15, 17 can be at least 1.5 mm at the closest point and at most 10 mm at the widest point.

The exemplary embodiments show and describe possible embodiments of the component 1, yet it should be noted at this point that combinations of the individual embodiments with one another are also possible.

For the sake of good order and better understanding of the structure of the component 1, it is noted here that the latter is not necessarily shown to scale.

### LIST OF REFERENCE NUMERALS

1 Component
2 Toothing
3 Tooth
4 Tooth flank
5 Tooth tip
6 Tooth root
7 Root circle
8 Tip circle
9 Component body
10 Bonding layer
11 Diffusion layer
12 Annular part
13 Annular part
14 Radial direction
15 Projection
16 Circumferential direction
17 Projection
18 Elastomer element

1. A method for manufacturing a component (1), in particular annular, having a toothing (2), which has teeth (3) with tooth roots (6), tooth tips (5) and tooth flanks (4), comprising the steps of: manufacturing a component body (9) from a metallic material, forming the toothing (2) on the component body (9), mechanically finishing the toothing (2) so that the surface of the toothing (2) has a first surface roughness, wherein, after the mechanical finishing, the toothing (2) is heat treated to form a second surface roughness of the mechanically finished surface, which is less than the first surface roughness, and/or wherein the component body (9) is configured to be divided in the radial direction, forming a first radially inner annular part (12) and a second radially outer annular part (13), an elastomer being arranged in an undulating manner between the first radially inner and the second radially outer annular part (12, 13).

2. The method according to claim 1, wherein the toothing (2) is manufactured simultaneously with the component body (9).

3. The method according to claim 1, wherein the component body (9) is manufactured from a sintered material by pressing a powder to form a green compact and sintering the green compact to form the component body (9).

4. The method according to claim 3, wherein at least the toothing is re-compressed after sintering.

5. The method according to claim 1, wherein machining is carried out as mechanical finishing.

6. The method according to claim 1, wherein a nitration or nitro-carburization is carried out as the heat treatment.

7. The method according to claim 6, wherein a plasma nitration is carried out as the nitration or plasma nitro-carburization is carried out as the nitro-carburization.

8. The method according to claim 1, wherein a radially inner surface of the second radially outer annular part (13) and a radially outer surface of the first radially inner annular part (12) are configured in a toothed manner.

9. The method according to claim 8, wherein the radially inner surface of the second radially outer annular part (13) and/or the radially outer surface of the first radially inner annular part (12) are rolled with and/or without a cutting tool.

10. The method according to claim 8, wherein the radially inner surface of the second radially outer annular part (13) and/or the radially outer surface of the first radially inner annular part (12) are configured in the form of a spur toothing or helical toothing.

11. The method according to claim 10, wherein the spur toothing or helical toothing of the radially inner surface of the second radially outer annular part (13) and/or the radially outer surface of the first radially inner annular part (13) are configured in the form of a cycloidal toothing, in particular an involute toothing.

12. A component (1), in particular an internal gear, having a component body (9) on which a toothing (2) is arranged or formed, which has teeth (3) with tooth roots (6), tooth tips (5) and tooth flanks (4), wherein the toothing (2) is mechanically finished, wherein the toothing (2) is heat treated and/or wherein the component body (9) is configured to be divided in the radial direction, forming a first radially inner annular part (12) and a second radially outer annular part (12), an elastomer being arranged in an undulating manner between the first and second annular parts (12 13).

13. The component (1) according to claim 12, wherein the toothing (2) has a maximum surface tension according to ISO 8296 DIN 53364 of 55 mN/m, in particular between 20 mN/m and 50 mN/m.

14. The component (1) according to claim 12, wherein the toothing (2) has a surface roughness with an arithmetic mean roughness Ra according to DIN EN ISO 4287:2010 between 0.025 μm and 2.5 μm.

15. The component according to claim 12, wherein a radially inner surface of the second radially outer annular part (13) and a radially outer surface of the first radially inner annular part (12) are configured in a toothed manner.

16. The component according to claim 15, wherein the radially inner surface of the second radially outer annular part (13) and/or the radially outer surface of the first radially inner annular part (12) are rolled with and/or without a cutting tool.

17. The component according to claim 15, wherein the radially inner surface of the second radially outer annular part (13) and/or the radially outer surface of the first radially inner annular part (12) are configured in the form of a spur toothing or helical toothing.

18. The component according to claim 17, wherein the spur toothing or helical toothing of the radially inner surface of the second radially outer annular part (13) and/or the radially outer surface (12) of the first radially inner annular part is configured in the form of a cycloidal toothing, in particular an involute toothing.
